(19) United States
(12) Patent Application Publication
(10) Pub. No.: US 2026/0189156 A1
(43) Pub. Date: Jul. 2, 2026

(54) MULTI-LEVEL CONVERTING APPARATUS

(71) Applicant: ABB E-mobility B.V., Delft (NL)

(72) Inventors: Fan Zhang, Shenzen (CN); Yin Tang, Shenzen (CN); Bing Huang, Shenzhen (CN); KuenFaat Yuen, Hong Kong (CN)

(21) Appl. No.: 19/552,477

(22) Filed: Feb. 27, 2026

Related U.S. Application Data
(63) Continuation of application No. PCT/CN2024/076355, filed on Feb. 6, 2024.

(51) Int. Cl. H02M 7/483; H02M 3/00; H02M 3/335

(52) U.S. Cl. CPC H02M 7/4837; H02M 3/01; H02M 3/33573; H02M 3/33584

(57) ABSTRACT

Embodiments of the present disclosure relate to a multi-level converting apparatus comprising: a controllable DC source configured to regulate its output voltage; and a multi-level flying capacitor converter connected to an output of the controllable DC source and having one or more flying capacitors; wherein the multi-level converting apparatus is configured such that a pre-charging voltage increases while a pre-charging current decreases during a pre-charging state for the one or more flying capacitors.

### CLAIM FOR PRIORITY

This application is a continuation of and claims the benefit of International Application No. PCT/CN2024/076355, filed February 6, 2024, which is hereby incorporated by reference in its entirety.

### FIELD OF THE INVENTION

This invention relates to the electrical field, and more particularly, to a multi-level converting apparatus.

### BACKGROUND OF THE INVENTION

It is becoming more and more strict for the requirement of EV charging and energy storage related markets. One of the requirements is high voltage and wide output range, which makes both the related power semiconductor switches and the power converter system work in a harsh condition. Owing to the benefits of the multi-stage and multi-level topologies, such multi-stage and multi-level topologies are more and more widely applied in various applications to meet the above requirements.

Among the multi-stage and multi-level converters, a multi-level flying capacitor converter (MLFC) has been applied for years because of the advantage of high efficiency, low power semiconductors voltage stress and small volume.

### SUMMARY OF THE INVENTION

The invention is defined by the claims.

According to one aspect of the disclosure, there is provided a multi-level converting apparatus. The multi-level converting apparatus comprises: a controllable DC source configured to regulate its output voltage; and a multi-level flying capacitor converter connected to an output of the controllable DC source and having one or more flying capacitors; wherein the multi-level converting apparatus is configured such that a pre-charging voltage increases while a pre-charging current decreases during a pre-charging state for the one or more flying capacitors.

With the above multi-level converting apparatus, those skilled in the art would appreciate that the pre-charging time for the one or more flying capacitors can be reduced, and in the meantime, the voltage stress across the power switches in the multi-level flying capacitor converter can also be alleviated. Therefore, a better balance between the pre-charging time and the voltage stress for the power semiconductor switches can be achieved.

In some embodiments, the controllable DC source is configured to regulate its output voltage from zero to a specified voltage level during the pre-charging state.

In some embodiments, the multi-level converting apparatus further comprises: a discharging circuit connected to the output of the controllable DC source and in parallel with the multi-level flying capacitor converter, and having a discharging switch, such that when the discharging switch is turned on, the one or more flying capacitors is discharged via the discharging circuit.

In some embodiments, the controllable DC source is a DC/DC or AC/DC converter.

In some embodiments, the multi-level flying capacitor converter is an N level flying capacitor converter, wherein N is an integer larger or equal to 3.

In some embodiments, the output of the multi-level flying capacitor converter is connected to a load via an inductor, and wherein a buck or boost circuit can be formed by part of the multi-level flying capacitor converter and the inductor.

In some embodiments, the multi-level flying capacitor converter is a single unit, an interleaved multi-unit structure, a serial structure or a parallel structure.

In some embodiments, the power switches in the multi-level flying capacitor converter is selected from a group consisting of Si MOSFET, Si IGBT, SiC MOSFET and GaN MOSFET.

In some embodiments, the discharging circuit comprises a resistor connected in series with the discharging switch.

In some embodiments, the discharging switch comprises at least one power switch or a magnet relay.

In some embodiments, the at least one power switch is selected from a group consisting of Si MOSFET, Si IGBT, SiC MOSFET and GaN MOSFET.

In some embodiments, the controllable DC source is formed as a CLLC circuit.

In some embodiments, the multi-level converting apparatus further comprises: a sampling circuit for sampling the voltage of the one or more flying capacitors.

In some embodiments, the multi-level converting apparatus further comprises: a driving circuit for controlling a plurality of power switches in the multi-level flying capacitor converter.

According to another aspect of the disclosure, there is provided a power supply circuit comprising the multi-level converting apparatus as stated above.

### BRIEF DESCRIPTION OF THE DRAWINGS

In the drawings, similar/same reference signs throughout different views generally represent similar/same parts. Drawings are not necessarily on scale. Rather, emphasis is placed upon the illustration of the principles of the present invention. In these drawings:

FIG. 1 schematically illustrates a traditional multi-level converting apparatus;

FIG. 2 schematically illustrates a conceptual circuit diagram for an improved multi-level converting apparatus according to the present disclosure.

FIG. 3a schematically illustrates a first exemplary multi-level converting apparatus with a TLFC converter according to one embodiment of the present disclosure;

FIG. 3b schematically illustrates a pre-charging path for the multi-level converting apparatus of FIG. 3a;

FIG. 3c schematically illustrates a discharging path for the multi-level converting apparatus of FIG. 3a;

FIG. 4a schematically illustrates a second exemplary multi-level converting apparatus with a FLFC converter according to one embodiment of the present disclosure;

FIG. 4b schematically illustrates a first pre-charging path for one flying capacitor in the multi-level converting apparatus of FIG. 4a;

FIG. 4c schematically illustrates a second pre-charging path for another flying capacitor in the multi-level converting apparatus of FIG. 4a;

FIG. 4d schematically illustrates a discharging path for the multi-level converting apparatus of FIG. 4a;

FIG. 5 schematically illustrates an example of the multi-level converting apparatus according to one embodiment of the present disclosure, wherein a CLLC circuit serves as a first stage and a multi-level flying capacitor converter serves as a second stage; and

FIG. 6 illustrates the voltage or current wave form during the pre-charging and discharging state for the multi-level converting apparatus of FIG. 5.

### DETAILED DESCRIPTION OF THE EMBODIMENTS

Embodiments of the present disclosure will be described in more details with reference to the drawings. Although the drawings illustrate some embodiments of the present disclosure, it should be appreciated that the present disclosure can be implemented in various manners and should not be interpreted as being limited to the embodiments explained herein. On the contrary, the embodiments are provided to understand the present disclosure in a more thorough and complete way. It should be appreciated that drawings and embodiments of the present disclosure are only for exemplary purposes rather than restricting the protection scope of the present disclosure.

In the descriptions of the embodiments of the present disclosure, the term “includes” and its variants are to be read as open-ended terms that mean “includes, but is not limited to.” The term “based on” is to be read as “based at least in part on.” The terms “one embodiment” and “this embodiment” are to be read as “at least one embodiment.” The following text also can comprise other explicit and implicit definitions.

As mentioned before, a multi-level flying capacitor converter (MLFC) has been applied for years. As is known in the art, one challenge of the multi-level flying capacitor (MLFC) converter is the balance between its pre-charging time and voltage stress for the power semiconductor switches. Typically, the flying capacitor of MLFC should be charged to a specified voltage before power semiconductor switches start switching, and should be kept in a safe voltage range if fault happens.

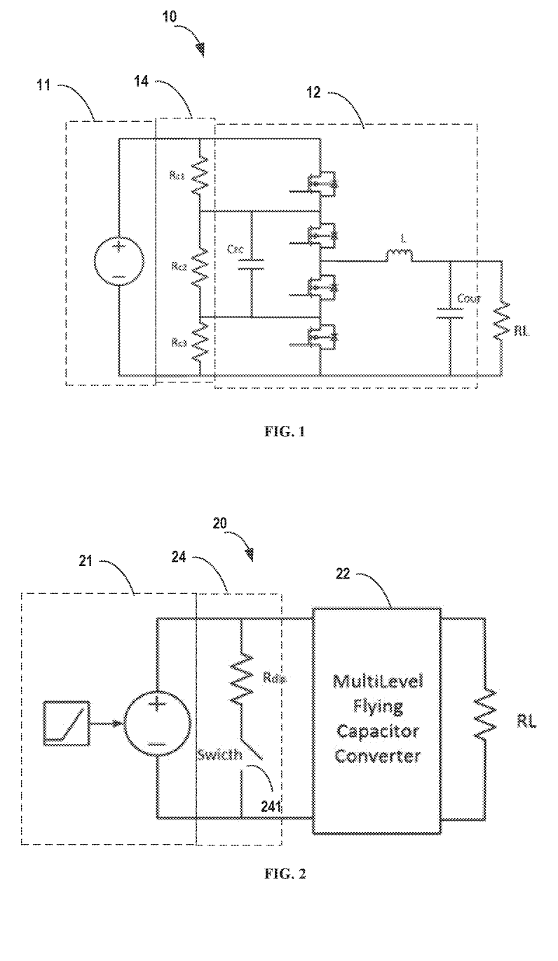

The traditional multi-level converting apparatus with the flying capacitors generally realises its pre-charging function with a series of passive resistors, as can be seen in FIG. 1.

As shown in FIG. 1, the traditional multi-level converting apparatus 10 generally comprises a DC source 11 with a fixed voltage output and a multi-level flying capacitor converter 12, wherein the multi-level flying capacitor converter 12 is configured to connect to the output of the DC source 11 and apply an output voltage to a load RL via an output circuit. Particularly, the multi-level flying capacitor converter 12 may be a three level flying capacitor (TLFC) converter comprising four power semiconductor switches connected in series and one flying capacitor C_{FC} connected in parallel with the two innermost power semiconductor switches. Further, a passive pre-charging resistor circuit 14 with a plurality of passive resistors Rc1, Rc2, Rc3 connected in series may also be connected to the output of the DC source 11 and an intermediate resistor Rc2 may be connected in parallel with the flying capacitor C_{FC.}

However, it is found that such a design of the above traditional multi-level converting apparatus 10 might result in a trade-off between the power loss of the passive resistors and pre-charging time of the flying capacitors. Meanwhile, there is no discharging loop in case of failure conditions.

In view of the above, the present disclosure proposes an improved multi-level converting apparatus, which comprises a controllable DC source configured to regulate its output voltage; and a multi-level flying capacitor converter connected to an output of the controllable DC source and having one or more flying capacitors; wherein the multi-level converting apparatus is configured such that a pre-charging voltage for the one or more flying capacitors increases while a pre-charging current for the one or more flying capacitors decreases during a pre-charging state. Those skilled in the art would appreciate that with the present improved multi-level converting apparatus, the pre-charging time can be reduced while the voltage across the power switches in the multi-level flying capacitor converter can be simultaneously reduced.

For better understanding of the concept of the present disclosure, FIG. 2 schematically illustrates a conceptual circuit diagram for the improved multi-level converting apparatus according to the present disclosure.

As shown in FIG. 2, the multi-level converting apparatus 20 may comprise a controllable DC source 21 and a multi-level flying capacitor converter 22. Similar to FIG. 1, the multi-level flying capacitor converter 22 is also connected to the output of the DC source 11 and configured to apply an output voltage to a load RL. However, the multi-level converting apparatus 20 of the present disclosure differs from the one in FIG. 1 in that: the DC source is controllable such that its output voltage may be regulated, e.g., from zero to a specified voltage level during a pre-charging state. In addition, in some alternative embodiments, a discharging circuit 24 may be connected to an output of the controllable DC source 21 and in parallel with the multi-level flying capacitor converter 22.

Those skilled in the art will appreciate that with the design of multi-level converting apparatus 20, a two-stage circuit structure may be formed, wherein the controllable DC source 21 would be the front-end stage of the multi-level converting apparatus 20, and the multi-level flying capacitor converter 22 would be the behind stage of the multi-level converting apparatus 20. As a result, the regulated voltage from the controllable DC source 21 may be directly as the input voltage of the multi-level converting apparatus 20. Further, with the control of the multi-level converting apparatus 20, a pre-charging voltage for the one or more flying capacitors may increase, while a pre-charging current for the one or more flying capacitors may decrease during the pre-charging state.

In some embodiments, the controllable DC source 21 may be a controllable DC/DC or AC/DC converter. In some embodiments, the controllable DC/DC or AC/DC converter may be a two level converter or a multi-level converter. In some embodiments, the controllable DC/DC or AC/DC converter may be an isolated or non-isolate converter. Just as an example, the controllable DC source 21 may be a controllable CLLC DC/DC converter, as will be further described in detail.

As stated above, in some alternative embodiments, a discharging circuit 24 may be included, wherein the discharging circuit 24 may comprise a discharging switch 241 and a discharging resistor Rdis connected in series. Typically, the discharging switch 241 may comprise a power switch or a magnet relay. In some embodiments, the power switch may be a power semiconductor switch selected from a group consisting of Si MOSFET, Si IGBT, SiC MOSFET and GaN MOSFET.

As will be described thereafter, with the discharging circuit 24, the charge stored in one or more flying capacitors of the multi-level flying capacitor converter 22 may be discharged via the discharging circuit 24 as desired in case of failure conditions. In this way, the safety of the operation may be improved.

In some embodiments, the multi-level flying capacitor converter 22 may be a N-level flying capacitor converter, wherein N is an integer larger or equal to three. In some embodiments, the multi-level flying capacitor converter may be a single unit, an interleaved multi-unit structure, a serial structure or a parallel structure.

Typically, the multi-level flying capacitor converter 22 may have a plurality of power switches (e.g., power semiconductor switches), one or more flying capacitors and an output connected to a node between two innermost, adjacent power switches, wherein the one or more power switches may be connected in series, the one or more flying capacitors each may be connected in parallel with part of the power switches. In some embodiments, the power switch may be a power semiconductor switch selected from a group consisting of Si MOSFET, Si IGBT, SiC MOSFET and GaN MOSFET.

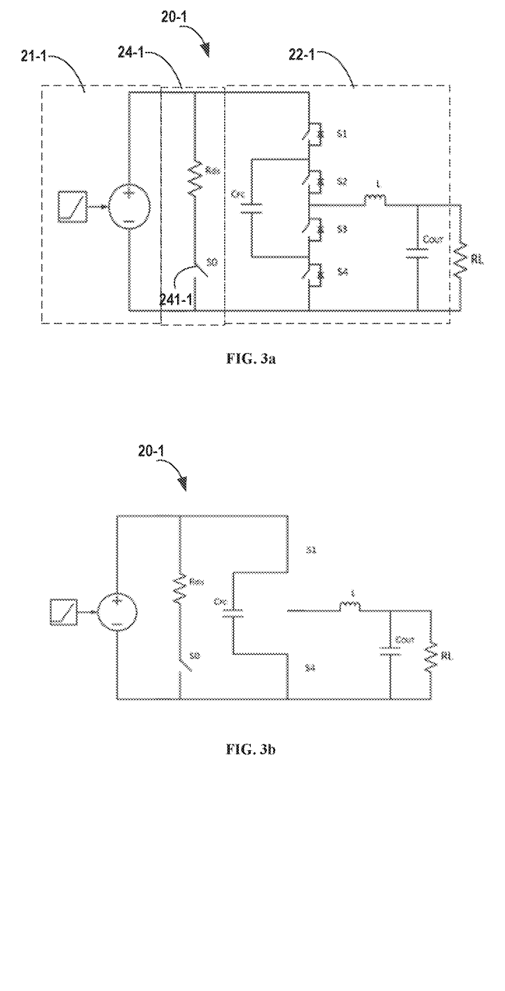

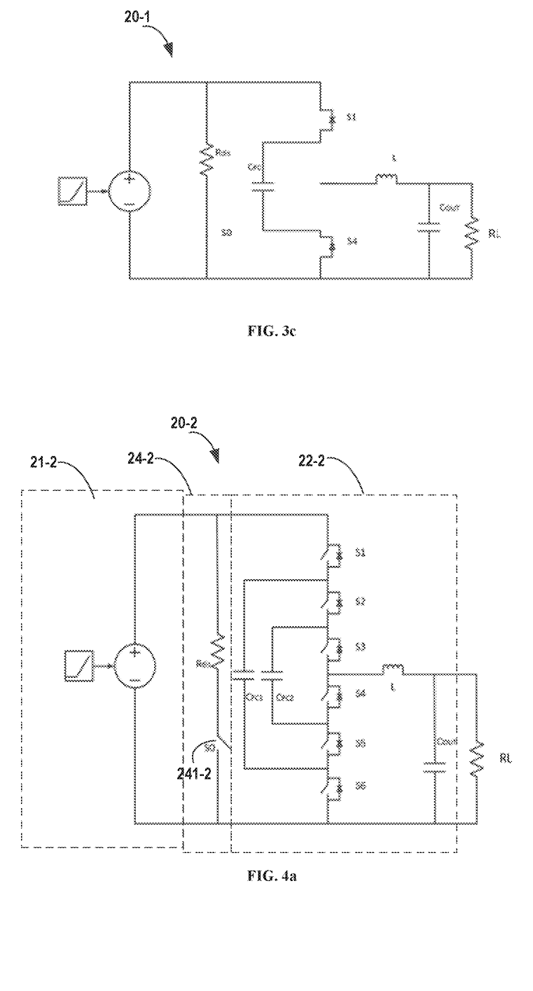

Just as an example, the multi-level flying capacitor converter 22 may be a three level flying capacitor (TLFC) converter. FIG. 3a illustrates a first exemplary multi-level converting apparatus with a TLFC converter according to one embodiment of the present disclosure.

As illustrated in FIG. 3a, the first exemplary multi-level converting apparatus 20-1 may comprise a controllable DC source 21-1, a three level flying capacitor converter 22-1 and an optional discharging circuit 24-1.

The three level flying capacitor converter 22-1 may comprise four power semiconductor switches S1, S2, S3, S4 connected in series, one flying capacitor C_{FC} connected in parallel with the two innermost power semiconductor switches S2 and S3, and an output 25-1 connected to a node between two innermost, adjacent power semiconductor switches S2, S3. The output 25-1 of three level flying capacitor converter 22-1 may be connected to a load RL via a LC circuit, wherein an inductor L is connected in series with the load RL and an output capacitor Cout is connected in parallel with the load RL.

The optional discharging circuit 24-1 may comprise a discharging switch 241-1 and a discharging resistor Rdis connected in series, and may be connected to the output of the controllable DC source 21-1 and in parallel with the three level flying capacitor (TLFC) converter 22-1.

During operation, the four power semiconductor switches S1, S2, S3, S4 may be controlled to allow the pre-charging or discharging of the flying capacitor C_{FC}. FIG. 3b illustrates a pre-charging path for the multi-level converting apparatus of FIG. 3a; and FIG. 3c illustrates a discharging path for the multi-level converting apparatus of FIG. 3a.

As shown in FIG. 3b, at a pre-charging state, the two outermost power semiconductor switches, i.e., S1, S4, may be turned on while the two innermost power semiconductor switches, i.e., S2, S3, may be turned off. Thereafter, the controllable DC source 21-1 may then be connected across the flying capacitor C_{FC}, to directly pre-charge the flying capacitor C_{FC.}

As shown in FIG. 3c, at a discharging state, all the power semiconductor switches S1, S2, S3, S4 are turned off while the discharging switch 241-1 are turned on. Thereafter, the voltage on the flying capacitor C_{FC} may discharge via the body diodes of the power semiconductor switches S1, S4 and the discharging circuit 24-1.

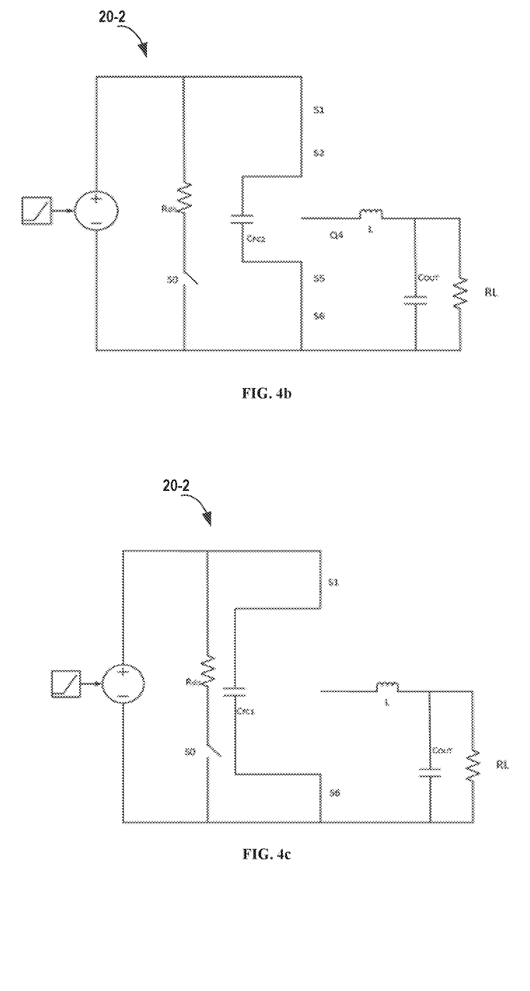

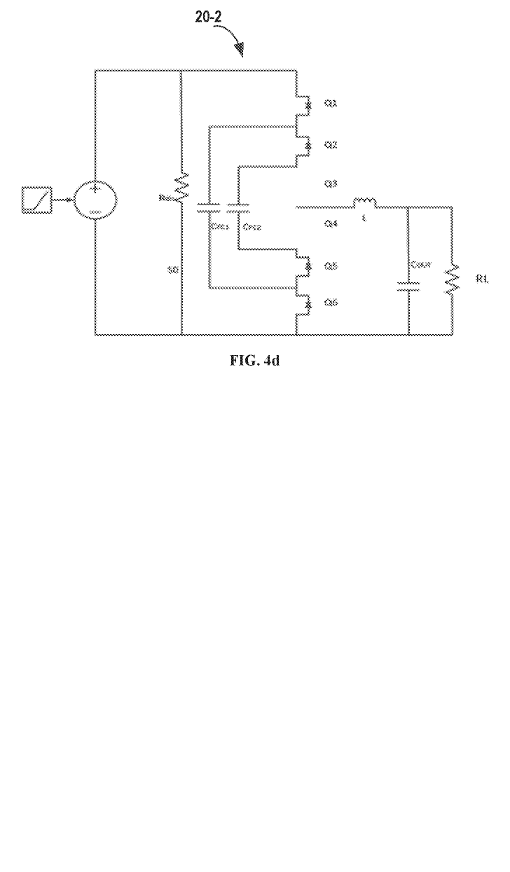

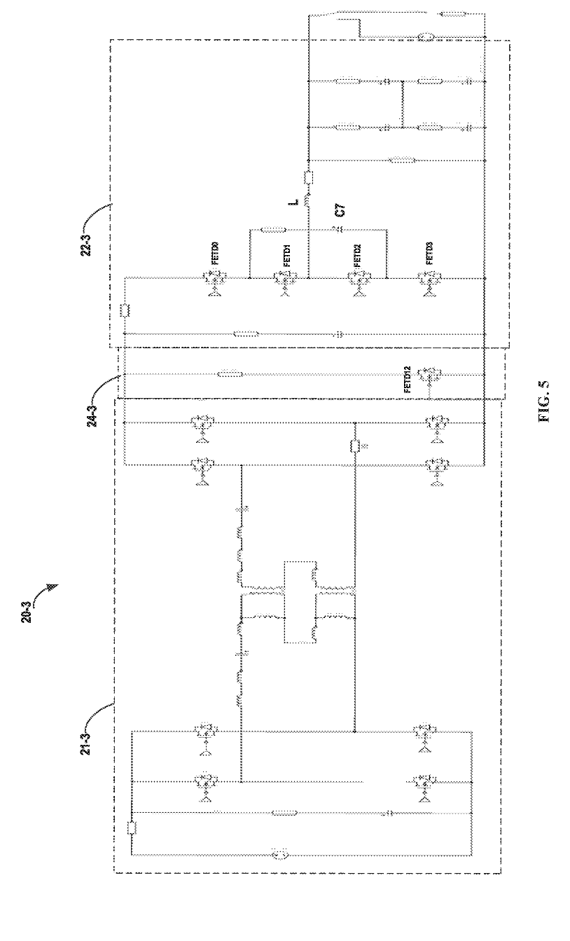

Just as another example, the multi-level flying capacitor converter 22 may be a four level flying capacitor (FLFC) converter. FIG. 4a illustrates a second exemplary multi-level converting apparatus with a FLFC converter according to one embodiment of the present disclosure.

As illustrated in FIG. 4a, the second exemplary multi-level converting apparatus 20-2 may comprise a controllable DC source 21-2, a four level flying capacitor converter 22-2 and an optional discharging circuit 24-2.

The four level flying capacitor converter 22-2 may comprise six power semiconductor switches S1, S2, S3, S4, S5, S6 connected in series and two flying capacitor C_{FC1,} C_{FC2}. The first flying capacitor C_{FC1} is connected in parallel with the two innermost power semiconductor switches S3 and S4, and the second flying capacitor C_{FC2} is connected in parallel with the four innermost power semiconductor switches S2, S3, S4 and S5.

The output 25-2 of the four level flying capacitor converter 22-2 is connected to a node between two innermost power semiconductor switches, i.e., S3 and S4. The output 25-1 of four level flying capacitor converter 22-1 may be connected to a load RL via a LC circuit, wherein an inductor L is connected in series with the load RL and an output capacitor Cout is connected in parallel with the load RL.

The optional discharging circuit 24-2 may comprise a discharging switch 241-2 and a discharging resistor Rdis connected in series, and may be connected to the output of an DC source 21-2 and in parallel with the four level flying capacitor converter 22-2.

During operation, the six power semiconductor switches S1, S2, S3, S4, S5 and S6 may be controlled to allow the pre-charging or discharging of the flying capacitor C_{FC}. FIG. 4b illustrates a first pre-charging path for one flying capacitor in the multi-level converting apparatus of FIG. 4a; FIG. 4c illustrates a second pre-charging path for another flying capacitor in the multi-level converting apparatus of FIG. 4a; and FIG. 4d illustrates a discharging path for the multi-level converting apparatus of FIG. 4a.

At a pre-charging state, as shown in FIG. 4b, the four outermost power semiconductor switches, i.e., S1, S2, S5, S6 may be turned on while two innermost power semiconductor switches, i.e., S3, S4 may be turned off, to pre-charge one of the two flying capacitors, e.g., C_{FC2} to a specified voltage V2. Thereafter, as shown in FIG. 4c, the two outermost power semiconductor switches, i.e., S1 and S6 may be kept turned-on while the power switches S2, S5 may then be turned off, to continue pre-charging the flying capacitor C_{FC1} to a specified voltage V1.

As shown in FIG. 4c, at a discharging state, all the power semiconductor switches S1, S2, S3, S4, S5, S6 are turned off while the discharging switch 241-2 are turned on. In this case, the voltage on the two flying capacitors, i.e., C_{FC1} and C_{FC2} may discharge via the body diodes of the power semiconductor switches S1, S2, S5, S6 and the discharging circuit 24-2.

Various embodiments are described with respect to the pre-charging or discharging function of the multi-level converting apparatus. It is noted that although it is not illustrated above, those skilled in the art may further appreciate that the plurality of power switches may further be controlled to supply the voltage of the one or more flying capacitors to the load RL, e.g., via a buck or boost circuit and/or a filter circuit. Typically, the buck or boost circuit may be formed by part of the switches of the multi-level flying capacitor converter and an inductor connected to the output of the multi-level flying capacitor converter 22.

In addition to the above, in some embodiments, the multi-level converting apparatus may further comprise a sampling circuit for sampling the voltage of the one or more flying capacitors.

In some embodiments, the multi-level converting apparatus may further comprise a driving circuit for controlling a plurality of power semiconductor switches in the multi-level flying capacitor converter.

In some embodiments, the multi-level converting apparatus may further comprise some logic units for the plurality of MLFC power switches and the discharging switch.

Typically, the above sampling circuit and the logic units each may be realized by an analog circuit, a digital circuit, or a function module integrated in a digital signal processor (DSP).

To verify the feasibility of the present disclosure, FIG. 5 schematically illustrates an example of the multi-level converting apparatus according to one embodiment of the present disclosure, wherein a controllable CLLC circuit serves as a first stage and a multi-level flying capacitor converter serves as a second stage.

It is known in the art that the CLLC topology is commonly applied for battery integration. It provides galvanic separation, the ability to integrate a high-frequency transformer into the resonance circuit, and the ability to operate in a wide range of voltage. Moreover, it assures zero voltage switching conditions for all switches and zero current switching conditions for secondary side switches, which enables obtaining high efficiency. Also, it may be convenient to provide a bidirectional converter with the CLLC topology.

As shown in FIG. 5, the multi-level converting apparatus 20-3 may comprise a controllable DC source 21-3 as a first stage and a multi-level flying capacitor converter 22-3 as a second stage, wherein an input of the multi-level flying capacitor converter 22-3 is connected to an output of the DC source 21-3 and has one flying capacitors C7. In addition, the multi-level converting apparatus 20-3 is configured with a discharging circuit 24-3.

Particularly, the controllable DC source 21-3 is formed as a CLLC circuit, and the multi-level flying capacitor converter 22-3 is realized by a three level flying capacitor converter. In this way, a wide input, output voltage range and an isolation requirement may be easily realized.

As the output voltage of the controllable DC source 21-3 is the input voltage of the multi-level flying capacitor converter 22-3, it then may be regulated with a determined PFM/PWM strategy and a logic unit in a proper ramp up time.

At the pre-charging stage, the controllable DC source 21-3 and the multi-level flying capacitor converter 22-3 may then work together to complete the pre-charging task of the flying capacitor C7. Just as an example, the controllable DC source 21-3 may for example regulate its output voltage from 0V to 950V slowly, and the FETD0 and FETD3 may be turned on until the flying capacitor C7 is charged to 450V, which may be about half of the desired input voltage. That is, even in the case that the flying capacitor is pre-charged to its specified voltage, the input voltage of the multi-level flying capacitor converter will continue to be controlled to ramp up to its desired voltage.

At the discharging stage, neither the controllable DC source 21-3 nor the multi-level flying capacitor converter 22-3 should work. For example, the controllable DC source 21-3 and the multi-level flying capacitor converter 22-3 both will stop working, and the discharging switch FETD12 (i.e., the discharging switch) may be turned on until the voltage of the flying capacitor is discharged to 0V, so as to ensure the safety in case of some failure conditions.

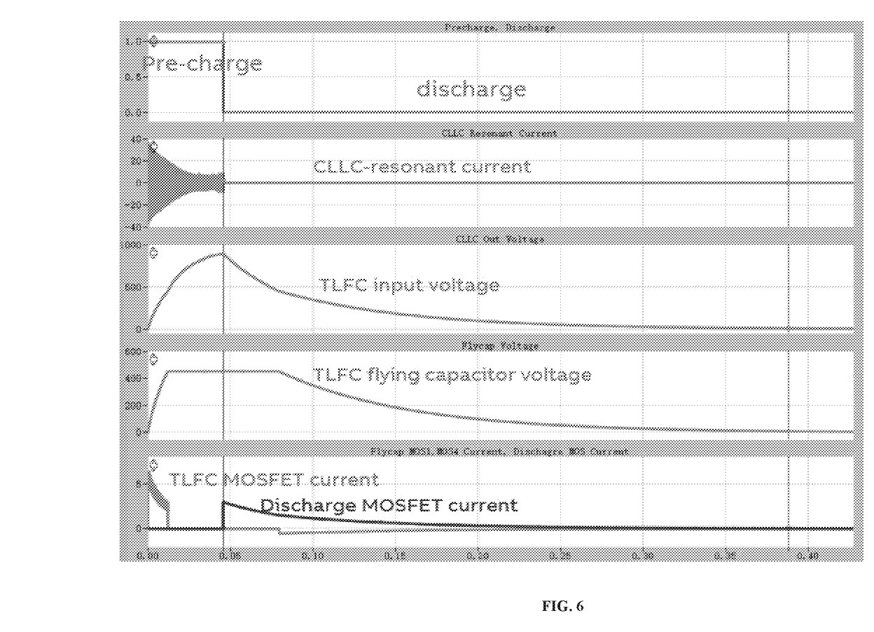

FIG. 6 illustrates the voltage or current wave form during the pre-charging and discharging state for the multi-level converting apparatus of FIG. 5.

As shown in FIG. 6, during the pre-charging state, the pre-charging current (referred to as “the CLLC-resonant current” in FIG. 6) for the flying capacitor is controlled to gradually decrease, while the pre-charging voltage (referred to as “the TLFC input voltage” in FIG. 6) for the flying capacitor is controlled to gradually increase or ramp up.

With the above control manner, those skilled in the art would appreciate that the voltage stress on the power switches in the multi-level flying capacitor converter 22-3 may then be reduced. Further, due to the pre-charging current being set to be initially large, the total pre-charging time for the flying capacitor may also be reduced. A better balance between the pre-charging time and the voltage stress across the power switches can then be realized. Also, power loss on the passive resistors can also be reduced.

Also, with the above configuration of the present apparatus, the discharging time can be controlled to a reasonable amount.

Through simulation, it can be found that with the multi-level converting apparatus 20-3, the pre-charging time can be reduced to be less than 50 ms, and the discharging time can be controlled to be less than 500 ms with reasonable power loss on the discharging resistor, thereby verifying the feasibility of the present disclosure.

In addition to the above, those skilled in the art could further appreciate that the above time-level sequence is quite easy for a digital signal processor (DSP) or microcontroller (MCU) to process, which enables the sampling and processing function module to be easily integrated in the digital signal processor (DSP) or microcontroller (MCU), and also makes a big cost-down and complexity reduction.

Also, those skilled in the art would appreciate that the present disclosure is not limited to a multi-level converting apparatus, but may also relate to a power supply circuit which includes the multi-level converting apparatus as described above.

To sum up, the present disclosure generally presents a cost-effective multi-level converting apparatus with a multilevel flying capacitor (MLFC) converter, which may have the following advantages:

Reduced pre-charging and discharging time. This is because the apparatus adopts an active control strategy rather than a passive strategy for pre-charging or discharging the multilevel flying capacitor(MLFC) converter, which makes the pre-charging time relatively small and regulatable. It is particularly advantageous for fast start-up and shut down applications like EV fast charging.

Low circuit complexity, low cost and high reliability. This is because the apparatus adds very little outside components for the conventional multi-level flying capacitor (MLFC) converter.

With the above advantages, those skilled in the art would appreciate that the present application may be particularly applied to the following scenarios, including but not limited to: EV charging applications, solar system applications, industrial applications, consumer electronic application, and other related applications.

Other variations to the disclosed embodiments can be understood and effected by those skilled in the art in practicing the claimed invention, from a study of the drawings, the disclosure, and the appended claims. In the claims, the word "comprising" does not exclude other elements or steps, and the indefinite article "a" or "an" does not exclude a plurality. The mere fact that certain measures are recited in mutually different dependent claims does not indicate that a combination of these measures cannot be used to advantage. Any reference signs in the claims should not be construed as limiting the scope.

1. A multi-level converting apparatus comprising:
a controllable DC source configured to regulate its output voltage; and
a multi-level flying capacitor converter connected to an output of the controllable DC source and having one or more flying capacitors;
wherein the multi-level converting apparatus is configured such that a pre-charging voltage increases while a pre-charging current decreases during a pre-charging state for the one or more flying capacitors.

2. The multi-level converting apparatus of claim 1, wherein the controllable DC source is configured to regulate its output voltage from zero to a specified voltage level during the pre-charging state.

3. The multi-level converting apparatus of claim 1, further comprising:
a discharging circuit connected to the output of the controllable DC source and in parallel with the multi-level flying capacitor converter, and having a discharging switch, such that when the discharging switch is turned on, the one or more flying capacitors is discharged via the discharging circuit.

4. The multi-level converting apparatus of claim 1, wherein the controllable DC source is a DC/DC or AC/DC converter.

5. The multi-level converting apparatus of claim 1, wherein the multi-level flying capacitor converter is an N level flying capacitor converter, wherein N is an integer larger or equal to 3.

6. The multi-level converting apparatus of claim 1, wherein the output of the multi-level flying capacitor converter is connected to a load via an inductor, and
wherein a buck or boost circuit can be formed by part of the multi-level flying capacitor converter and the inductor.

7. The multi-level converting apparatus of claim 1, wherein the multi-level flying capacitor converter is a single unit, an interleaved multi-unit structure, a serial structure or a parallel structure.

8. The multi-level converting apparatus of claim 1, wherein the power switches in the multi-level flying capacitor converter is selected from a group consisting of Si MOSFET, Si IGBT, SiC MOSFET and GaN MOSFET.

9. The multi-level converting apparatus of claim 3, wherein the discharging circuit comprises a resistor connected in series with the discharging switch.

10. The multi-level converting apparatus of claim 8, wherein the discharging switch comprises at least one power switch or a magnet relay.

11. The multi-level converting apparatus of claim 10, wherein the at least one power switch is selected from a group consisting of Si MOSFET, Si IGBT, SiC MOSFET and GaN MOSFET.

12. The multi-level converting apparatus of claim 1, wherein the controllable DC source is formed as a CLLC circuit.

13. The multi-level converting apparatus of claim 1, further comprising a sampling circuit for sampling the voltage of the one or more flying capacitors.

14. The multi-level converting apparatus of claim 1, further comprising a driving circuit for controlling a plurality of power switches in the multi-level flying capacitor converter.

15. A power supply circuit comprising:
the multi-level converting apparatus according to claim 1.
